(19) United States
(12) Patent Application Publication
(10) Pub. No.: US 2012/0247297 A1
(43) Pub. Date: Oct. 4, 2012

(54) CUTTING APPARATUS AND CUTTING CONTROL PROGRAM THEREFOR

(75) Inventors: Yasuhiko Kawaguchi, Nagoya-shi (JP); Yoshinori Nakamura, Toyohashi-shi (JP); Masahiko Nagai, Nagoya-shi (JP); Tomoyasu Niizeki, Ichinomiya-shi (JP); Katsuhisa Hasegawa, Kasugai-shi (JP)

(73) Assignee: BROTHER KOGYO KABUSHIKI KAISHA, Nagoya-shi (JP)

(21) Appl. No.: 13/421,950

(22) Filed: Mar. 16, 2012

(30) Foreign Application Priority Data
Mar. 30, 2011 (JP) 2011-075577
Mar. 30, 2011 (JP) 2011-075579

(51) Int. Cl. B26D 5/00; B26D 7/02

(52) U.S. Cl. 83/375; 83/465

(57) ABSTRACT

A cutting apparatus is disclosed in which a cutting blade and an object to be cut are moved relative to each other so that the object is cut by the cutting blade. The cutting apparatus includes a holding member which is disposed at a position opposed to the cutting blade and has an adhesive layer removably holding the object, and a pressing unit which presses the object held by the holding member, the pressing unit being set to a pressing force which meets a holding force necessary for a resultant force to immovably hold the object relative to the holding member when the object is cut by the cutting blade, the resultant force having an adhesion of the adhesive layer and the pressing force of the pressing unit both as components.

### CROSS-REFERENCE TO RELATED APPLICATIONS

This application is based upon and claims the benefit of priority from the prior Japanese Patent Application Nos. 2011-075577 and 2011-075579 both filed on Mar. 30, 2011, the entire contents of which are incorporated herein by reference.

### BACKGROUND

1. Technical Field

The present disclosure relates to a cutting apparatus in which a cutting blade and an object to be cut are moved relative to each other so that the object is cut by the cutting blade and a storage medium which is computer-readable and stores a control program on which the object is cut into a desirable shape.

2. Related Art

There has conventionally been known a cutting plotter which automatically cuts a sheet-like object to be cut, such as paper or resin sheet. The cutting plotter includes a drive mechanism having rollers which hold the object from the vertical direction so that the object is moved in a first direction. The drive mechanism also includes a carriage having a cutting blade which is moved in a second direction perpendicular to the first direction, whereby the object is cut.

FIG. 17 schematically illustrates an ordinary cutter (a cutting blade) 100 and a cutter holder 101 both provided in the conventional cutting plotter. As shown, the cutter 100 is fixed to a lower end of a bar-like cutter mount 102 by a screw 103. The cutter mount 102 is supported by a bearing 104 attached to a recess 101a formed in the lower end of the cutter holder 101, whereby the cutter mount 102 is rotatable about an axis line O. Furthermore, the cutter 100 has a blade edge 100a which is offset by a predetermined distance d relative to the axis line O. Accordingly, when the cutter 100 and a sheet 105 are moved relative to each other so that the sheet 105 is cut by the cutter 100, the blade edge 100a of the cutter 100 is subjected to a resistive force (reactive force) from the sheet 105 such that the cutter mount 102 is rotated about the axis line O. More specifically, the direction of the blade edge 100a of the cutter 100 is automatically changed according to a moving direction in which the cutter 100 and the sheet 105 are moved relative to each other.

Additionally, one of the above-described type cutting plotters is provided in which a sheet such as paper is pressed from upward by a biasing plate thereby to be prevented from floating. In this cutting plotter, the sheet around the cutter can be pressed by the aforementioned biasing plate so as not to float. However, when a part of desired shape has been cut out of the sheet, a driving force of the drive mechanism is not transferred to the cut-out portion of the sheet. Accordingly, the sheet cannot be moved correctly.

In view of the above-described problem, an improved cutting plotter is proposed in which a sheet such as paper is affixed to a sheet-like member (corresponding to a holding member) having an adhesive layer on a surface thereof. In this case, the sheet can strongly be held when the adhesion of the adhesive layer is increased. However, it becomes difficult to remove the sheet from the sheet-like member when the adhesion of the adhesive layer is increased. On the other hand, when the adhesion of the adhesive layer is reduced, the sheet cannot strongly be supported although the sheet can easily be removed from sheet-like member. In this case, there is a possibility that the sheet would be displaced relative to the sheet-like member such that the sheet could not be cut accurately. More specifically, the conventional cutting plotters having strong and weak adhesions have respective defects, both of which defects have been desired to be improved.

### SUMMARY

Therefore, an object of the disclosure is to provide a cutting apparatus in which the object can reliably be held by the holding member and can accurately be cut and the object can easily be removed from the holding member.

The present disclosure provides a cutting apparatus in which a cutting blade and an object to be cut are moved relative to each other so that the object is cut by the cutting blade, the cutting apparatus comprising a holding member which is disposed at a position opposed to the cutting blade and has an adhesive layer removably holding the object; and a pressing unit which presses the object held by the holding member, the pressing unit being set at a pressing force which meets a holding force necessary for a resultant force of an adhesion of the adhesive layer and the pressing force of the pressing unit to immovably hold the object relative to the holding member when the object is cut by the cutting blade.

### BRIEF DESCRIPTION OF THE DRAWINGS

In the accompanying drawings:

FIG. 1 is a perspective view of the cutting apparatus according to a first embodiment, showing an inner structure thereof;

FIG. 2 is a plan view of the cutting apparatus;

FIG. 3 is a perspective view of a cutter holder;

FIG. 4 is a front view of the cutter holder, showing the state where a cutter has been descended;

FIG. 5 is a sectional view of the cutter holder, showing the case where the cuter has been ascended;

FIG. 6 is a sectional view taken along lines VI-VI in FIG. 4;

FIG. 7 is an enlarged front view of a gear;

FIG. 8 is an enlarged view of the vicinity of a distal end of the cutter during the cutting;

FIG. 9 is a schematic graph explaining the relationship between an adhesion of the holding member (an adhesive layer) and a type of the object;

FIG. 10 is a block diagram showing an electrical arrangement of the cutting apparatus;

FIG. 11 is a side view of a cutter holder and the neighbor thereof during the cutting;

FIG. 12 is a view similar to FIG. 11, showing a second embodiment;

FIGS. 13A and 13B are a view of an example of cutting line of the object and an enlarged view of a partial corner of the cutting line in FIG. 13A, respectively;

FIG. 14 is a flowchart showing an entire processing flow relating to depressing the object by a pressing unit;

FIG. 15 is a flowchart showing a flow of second speed setting processing;

FIG. 16 is a flowchart showing a flow of first speed setting processing; and

FIG. 17 is an enlarged sectional view of a distal end of the cutter holder generally used with a conventional cutting plotter.

### DETAILED DESCRIPTION

### First Embodiment

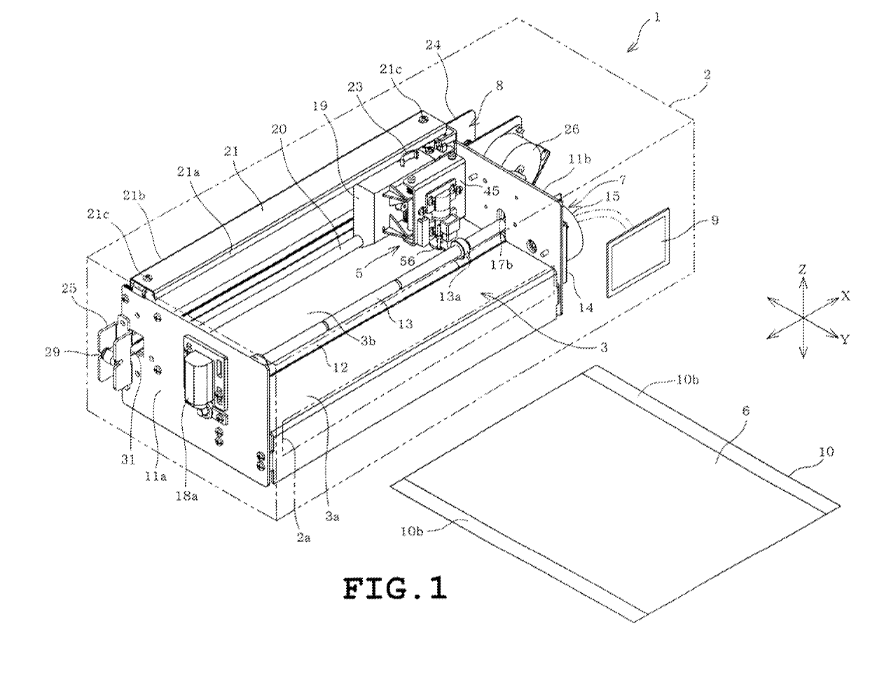

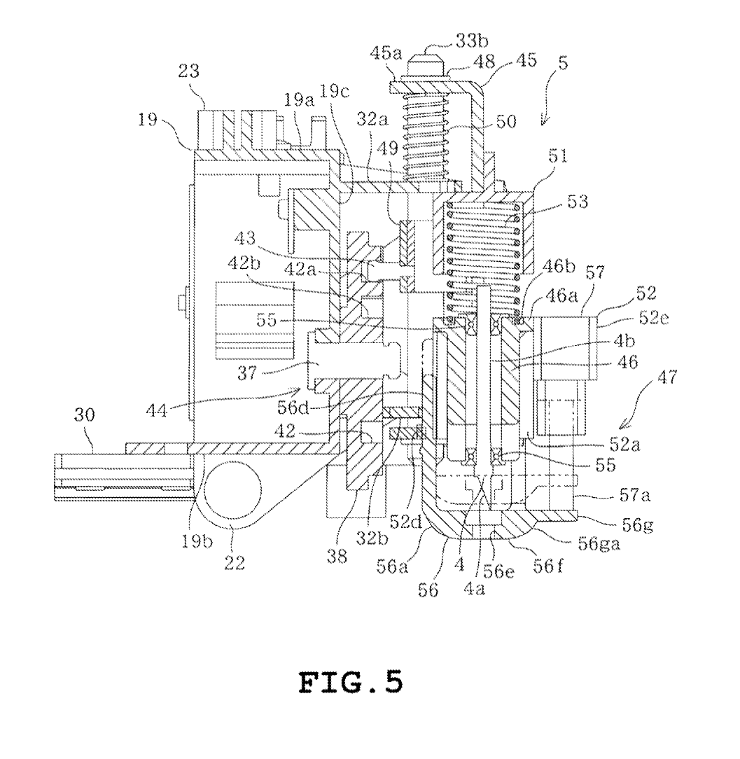

A first embodiment will be described with reference to FIGS. 1 to 11. Referring to FIG. 1, a cutting apparatus 1 includes a body cover 2 as a housing, a platen 3 provided in the body cover 2 and a cutter holder 5 also provided in the body cover 2. The cutting apparatus 1 also includes first and second moving units 7 and 8 for moving a cutter 4 (see FIG. 5) of the cutter holder 5 and an object 6 to be cut, relative to each other. The body cover 2 is formed into the shape of a horizontally long rectangular box and has a front formed with a horizontally long opening 2a which is provided for setting a holding sheet 10 holding the object 6. In the following description, the side where the user who operates the cutting apparatus 1 stands will be referred to as “front” and the opposite side will be referred to as “back.” The front-back direction thereof will be referred to as “Y direction.” The right-left direction perpendicular to the Y direction will be referred to as “X direction.”

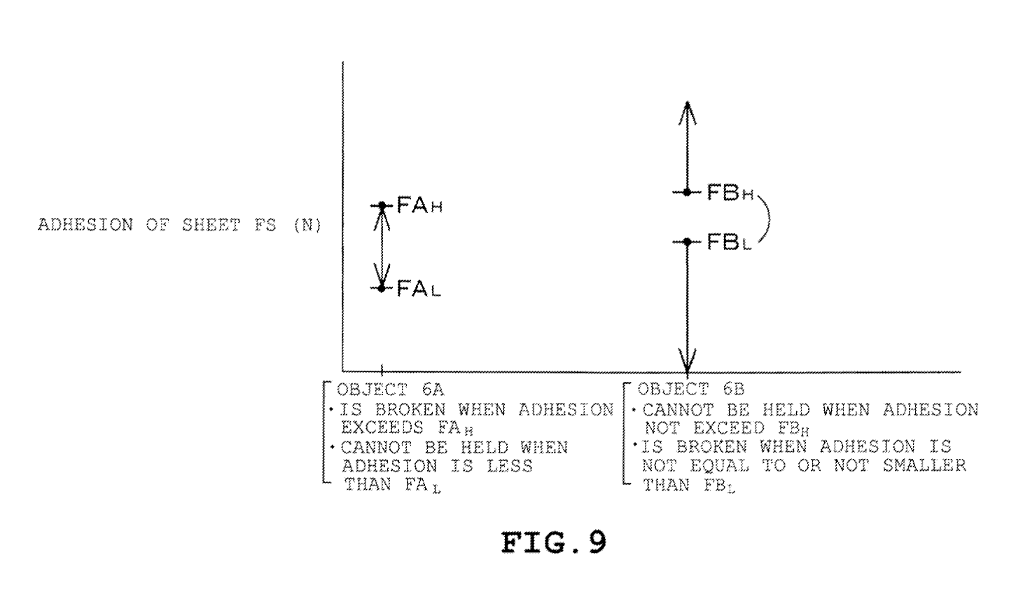

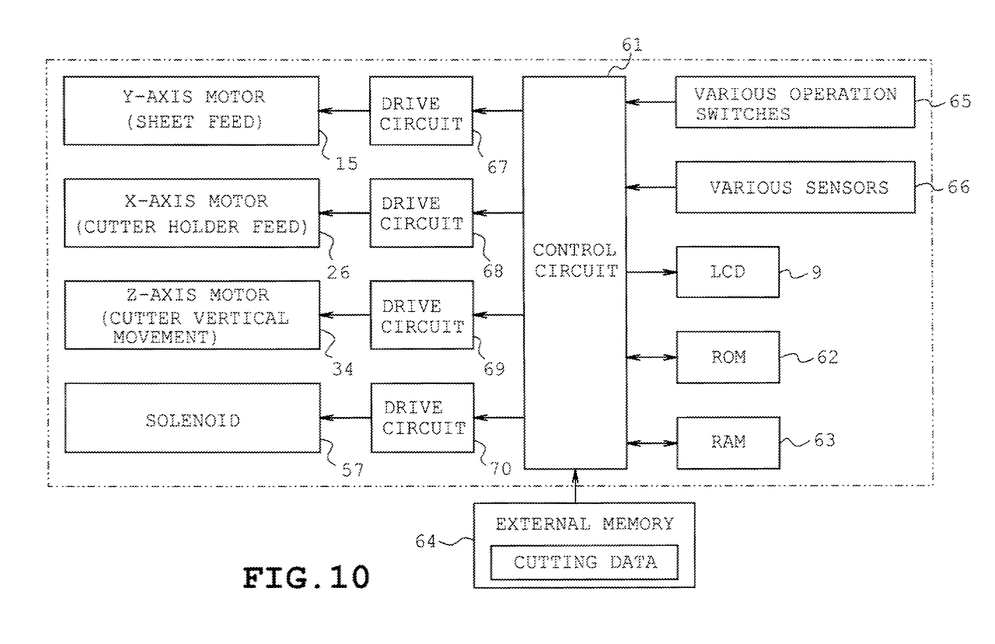

On a right part of the body cover 2 is provided a liquid crystal display (LCD) 9 which serves as a display unit displaying messages and the like necessary for the user. A plurality of operation switches 65 (see FIG. 10) is also provided on the right part of the body cover 2. The platen 3 includes a pair of front and rear plate members 3a and 3b and has an upper surface which is configured into an X-Y plane serving as a horizontal plane. The platen 3 is set so that the holding sheet 10 holding the object 6 is placed thereon. The holding sheet 10 is received by the platen 3 when the object 6 is cut. The holding sheet 10 has an upper surface with an adhesive layer 10a (see FIG. 8) formed by applying an adhesive agent to a part thereof except for right and left edges 10b. The object 6 is affixed to the adhesive layer 10a thereby to be held.

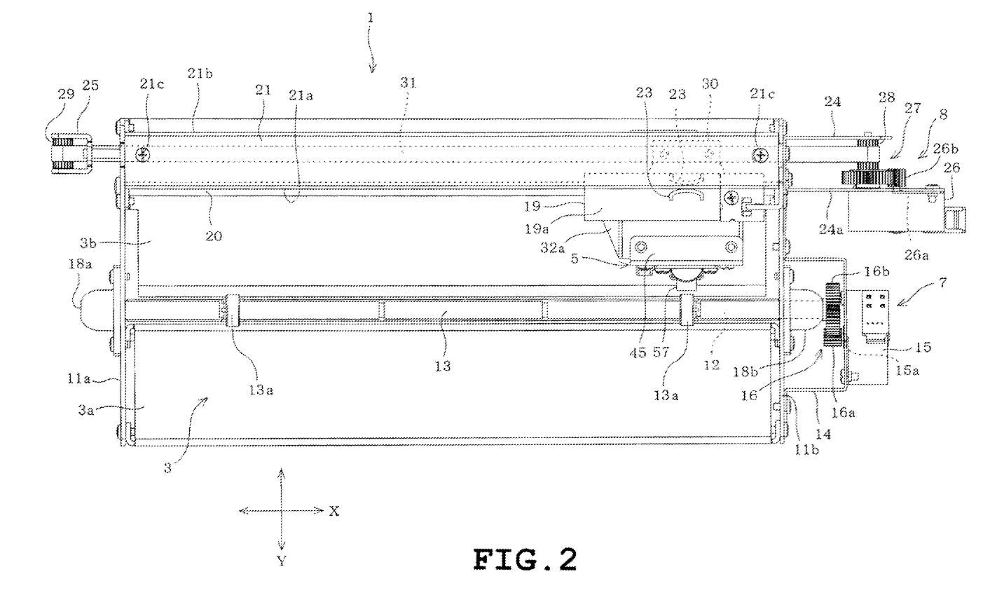

The first moving unit 7 moves the holding sheet 10 on the upper surface side of the platen 3 in the Y direction (a first direction). More specifically, a driving roller 12 and a pinch roller 13 are provided on right and left sidewalls 11b and 11a so as to be located between plate members 3a and 3b. The driving roller 12 and the pinch roller 13 extend in the X direction and are rotatably supported on the sidewalls 11b and 11a. The driving roller 12 and the pinch roller 13 are disposed so as to be parallel to the X-Y plane and so as to be vertically arranged. The driving roller 12 is located lower than the pinch roller 13. A first crank-shaped mounting frame 14 is provided on the right sidewall lib so as to be located on the right of the driving roller 12 as shown in FIG. 2. A Y-axis motor 15 is fixed to an outer surface of the mounting frame 14. The Y-axis motor 15 comprises a stepping motor, for example and has a rotating shaft 15a extending through the first mounting frame 14 and further has a distal end provided with a gear 16a. The driving roller 12 has a right end to which is secured another gear 16b which is brought into mesh engagement with the gear 16a. These gears 16a and 16b constitute a first reduction gear mechanism 16. The pinch roller 13 is guided by guide grooves 17b formed in the right and left sidewalls 11b and 11a so as to be movable upward and downward. Only the right guide groove 17b is shown in FIG. 1. Two spring accommodating members 18a and 18b are mounted on the right and left sidewalls 11b and 11a in order to cover the guide groove 17b from the outside respectively. The pinch roller 13 is biased downward by compression coil springs (not shown) accommodated in the spring accommodating portions 18a and 18b respectively. The pinch roller 13 is provided with pressing portions 13a which are brought into contact with a left edge 10b and a right edge 10c of the holding sheet 10, thereby pressing the edges 10b and 10c, respectively. Each pressing portion 13a has a slightly larger outer diameter than the other portion of the pinch roller 13.

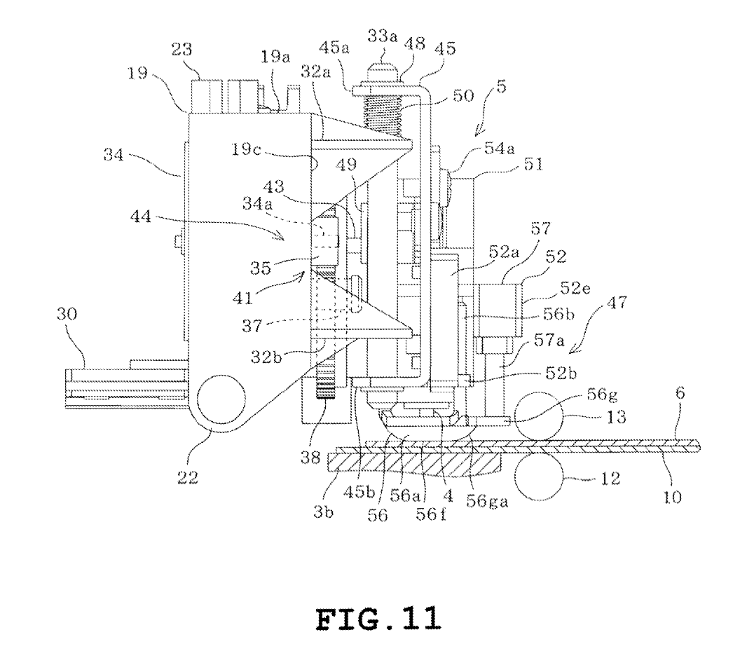

The driving roller 12 and the pinch roller 13 press the holding sheet 10 from below and from above by the urging force of the compression coil springs thereby to hold the holding sheet 10 therebetween (see FIG. 11). Upon drive of the Y-axis motor 15, normal or reverse rotation of the Y-axis motor 15 is transmitted via the first reduction gear mechanism 16 to the driving roller 12, whereby the holding sheet 10 is moved backward or forward together with the object 6. The first moving unit 7 is thus constituted by the driving roller 12, the pinch roller 13, the Y-axis motor 15, the first reduction gear mechanism 16, the compression coil springs and the like.

The second moving unit 3 moves a carriage 19 supporting the cutter holder 5 in the X direction (a second direction). The second moving unit 8 will be described in more detail. A guide shaft 20 and a guide frame 21 both extending in the right-left direction are provided between the right and left sidewalls 11b and 11a so as to be located at the rear end of the cutting apparatus 1, as shown in FIGS. 1 and 2. The guide shaft 20 is disposed in parallel with the driving roller 12 and the pinch roller 13. The guide shaft 20 located right above the platen 3 extends through a lower part of the carriage 19 (a through hole 22 as will be described later). The guide frame 21 has a front edge 21a and a rear edge 21b both folded downward such that the guide frame 21 has a generally C-shaped section. The front edge 21a is disposed in parallel with the guide shaft 20. The guide frame 21 is adapted to guide an upper part (guided members 23 as will be described later) of the carriage 19 by the front edge 21a. The guide frame 21 is fixed to upper ends of the sidewalls 11a and 11b by screws 21c respectively.

A second mounting frame 24 is mounted on the right sidewall 11b in the rear of the cutting apparatus 1, and an auxiliary frame 25 is mounted on the left sidewall 11a in the rear of the cutting apparatus 1, as shown in FIG. 2. An X-axis motor 26 and a second reduction gear mechanism 27 are provided on the second mounting frame 24. The X-axis motor 26 comprises a stepping motor, for example and is fixed to a front of a front mounting piece 24a. The X-axis motor 26 includes a rotating shaft 26a which extends through the mounting piece 24a and has a distal end provided with a gear 26b which is brought into mesh engagement with the second reduction gear mechanism 27. A pulley 28 is rotatably mounted on the second reduction gear mechanism 27, and another pulley 29 is rotatably mounted on the left auxiliary frame 25 as viewed in FIG. 2. An endless timing belt 31 connected to a rear end (a mounting portion 30 as will be described later) of the carriage 19 extends between the pulleys 28 and 29.

Upon drive of the X-axis motor 26, normal or reverse rotation of the X-axis motor 26 is transmitted via the second reduction gear mechanism 27 and the pulley 28 to the timing belt 31, whereby the carriage 19 is moved leftward or rightward together with the cutter holder 5. Thus, the carriage 19 and the cutter holder 5 are moved in the X direction perpendicular to the Y direction in which the object 6 is conveyed. The second moving unit 8 is constituted by the above-described guide shaft 20, the guide frame 21, the X-axis motor 26, the second reduction gear mechanism 27, the pulleys 28 and 29, the timing belt 31, the carriage 19 and the like.

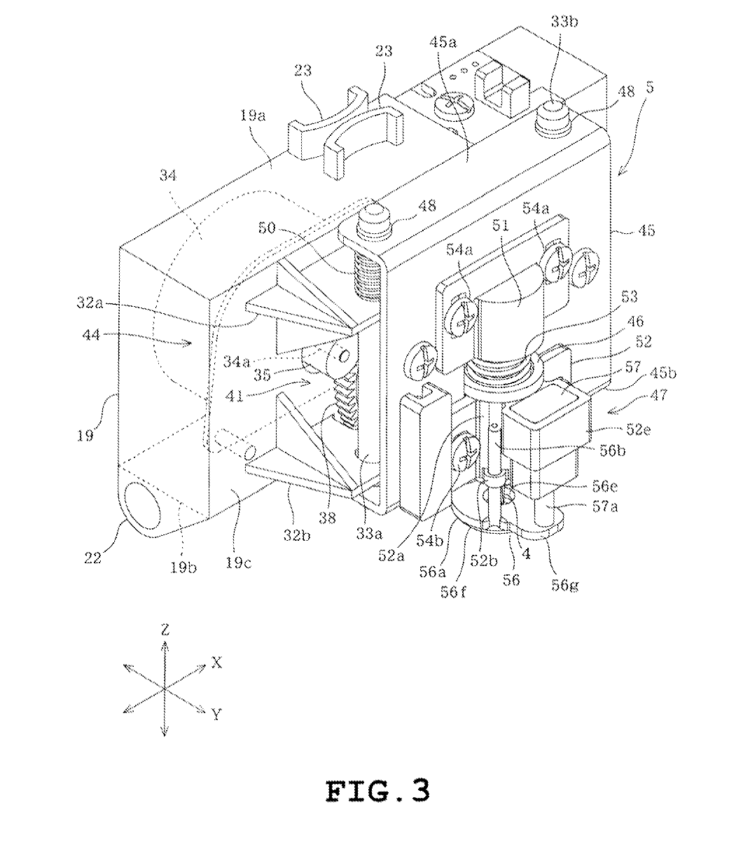

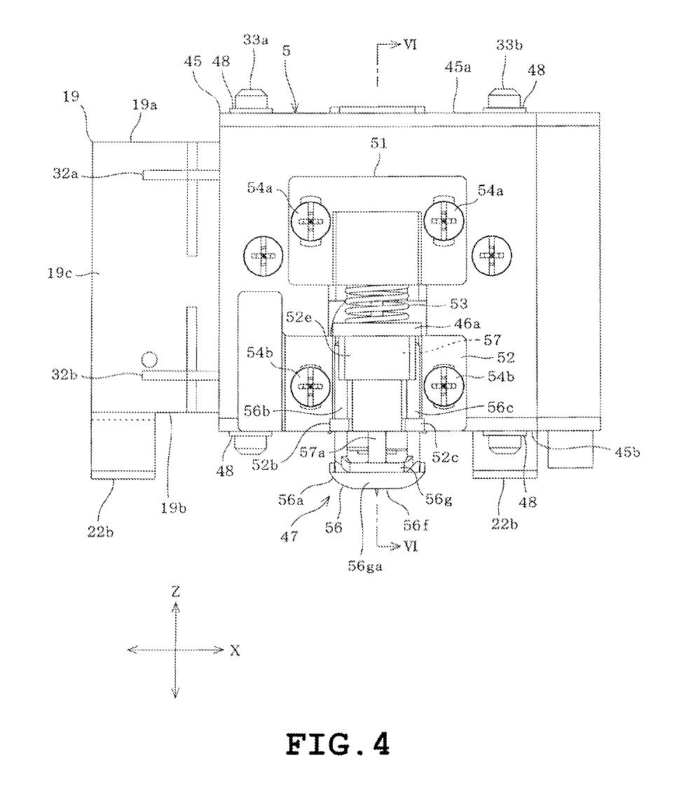

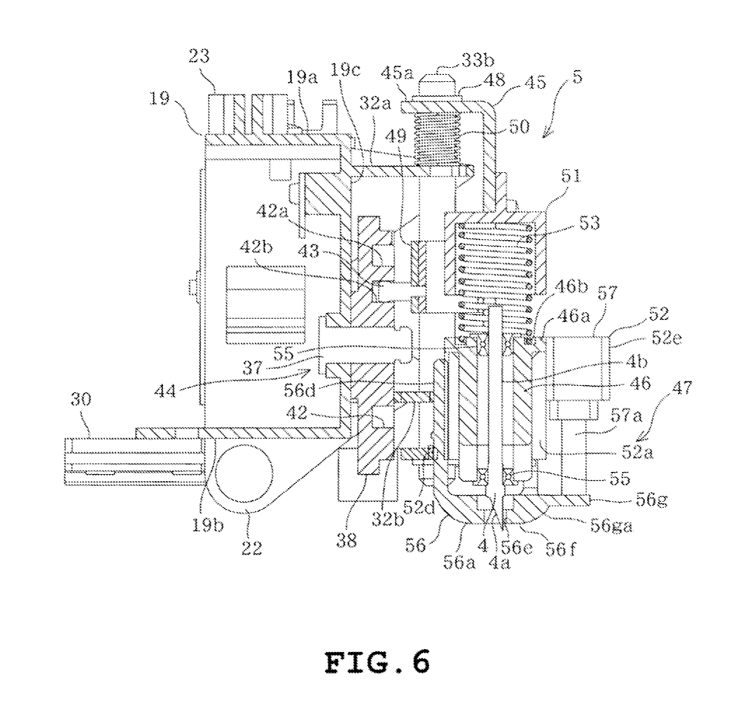

The cutter holder 5 is disposed on the front of the carriage 19 and is supported so as to be movable in a vertical direction (a third direction) serving as a Z direction. The carriage 19 and the cutter holder 5 will be described with reference to FIGS. 3 to 7 as well as FIGS. 1 and 2. The carriage 19 is formed into the shape of a substantially rectangular box with an open rear as shown in FIGS. 2 and 3. The carriage 19 has an upper wall 19a with which a pair of upwardly protruding front and rear guided members 23 are integrally formed. The guided members 23 are arc-shaped ribs as viewed in a planar view. The guided members 23 are symmetrically disposed with a front edge 21a of the guide frame 21 being interposed therebetween. The carriage 19 has a bottom wall 19b further having a downwardly expanding portion which is formed with a pair of right and left through holes 22 through which the guide shaft 20 is inserted, as shown in FIGS. 4, 5 and 6. An attaching portion 30 (see FIGS. 5 and 6) is mounted on the bottom wall 19b of the carriage 19 so as to protrude rearward. The attaching portion 30 is to be coupled with the timing belt 31. The carriage 19 is thus supported by the guide shaft 20 inserted through the holes 22 so as to be slidable in the right-left direction and further supported by the guide frame 21 held between the guided members 23 so as to be prevented from being rotated about the guide shaft 20.

The carriage 19 has a front wall 19c with which a pair of upper and lower support portions 32a and 32b are formed so as to extend forward as shown in FIGS. 3 to 5, 11, etc. A pair of right and left support shafts 33b and 33a extending through the respective support portions 32a and 32b are mounted on the carriage 19 so as to be vertically movable. A Z-axis motor 34 comprising, for example, a stepping motor is accommodated in the carriage 19 backward thereby to be housed therein. The Z-axis motor 34 has a rotating shaft 34a (see FIGS. 3 and 11) which extends through the front wall 19c of the carriage 19. The rotating shaft 34a has a distal end provided with a gear 35. Furthermore, the carriage 19 is provided with a gear shaft 37 which extends through a slightly lower part of the gear 35 relative to the central part of the front wall 19c as shown in FIGS. 5, 6 and 11. A gear 38 is rotatably mounted on the gear shaft 37 and adapted to be brought into mesh engagement with the gear 35 in front of the front wall 19c is rotatably mounted on the gear shaft 37. The gear 38 is retained by a retaining ring (not shown) mounted on a front end of the gear shaft 37. The gears 35 and 38 constitute a third reduction mechanism 41 (see FIGS. 3 and 11).

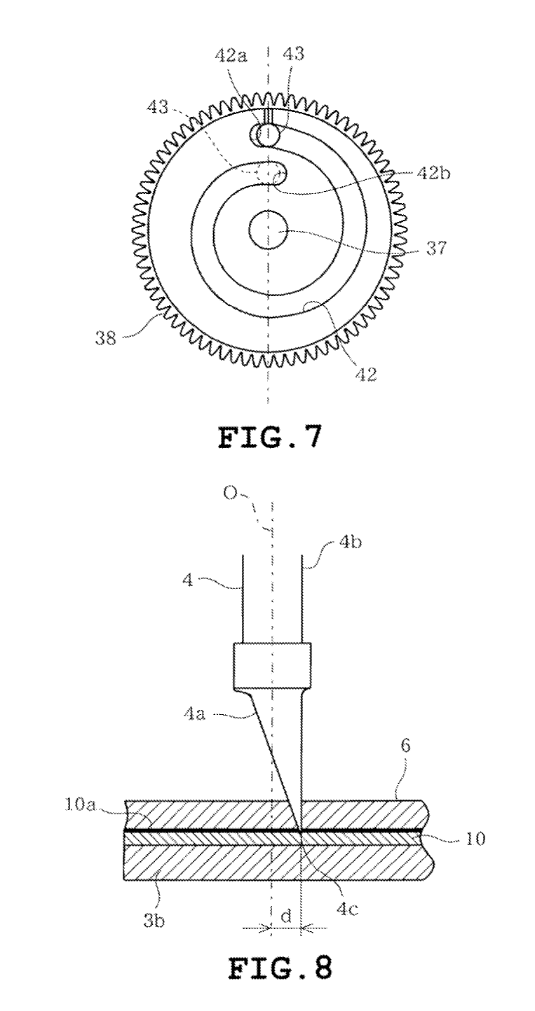

The gear 38 is formed with a spiral groove 42 as shown in FIG. 7. The spiral groove 42 is a cam groove formed into a spiral shape such that the spiral groove 42 comes closer to the center of the gear 38 as it is turned rightward from a first end 42a toward a second end 42b. An engagement pin 43 which is vertically moved together with the cutter holder 5 engages the spiral groove 42 (see FIGS. 5 and 6) as will be described in detail later. Upon normal or reverse rotation of the Z-axis motor 34, the gear 38 is rotated via the gear 35. Rotation of the gear 38 vertically slides the engagement pin 43 in engagement with the spiral groove 42. With the vertical slide of the gear 38, the cutter holder 5 is moved upward or downward together with the support shafts 33a and 33b. In this case, the cutter holder 5 is moved between a raised position (see FIGS. 5 and 7) where the engagement pin 43 is located at the first end 42a of the spiral groove 42 and a lowered position (see FIGS. 6 and 7) where the engagement pin 43 is located at the second end 92b. A third moving unit 44 which moves the cutter holder 5 upward and downward is constituted by the above-described third reduction mechanism 41 having the spiral groove 42, the Z-axis motor 34, the engagement pin 43, the support portions 32a and 32b, the support shafts 33a and 33b, etc.

The cutter holder 5 includes a holder body 45 provided on the support shafts 33a and 33b, a movable cylindrical portion 46 which has a cutter 4 (a cutting blade) and is held by the holder body 45 so as to be vertically movable and a pressing device 47 which presses the object 6. More specifically, the holder body 45 has an upper end 45a and a lower end 45b both of which are folded rearward such that the holder body 45 is generally formed into a C-shape, as shown in FIGS. 3 to 5, 11 and the like. The upper and lower ends 45a and 45b are immovably fixed to the support shafts 33a and 33b by retaining rings 48 fixed to upper and lower ends of the support shafts 33a and 33b, respectively. The support shaft 33b has a middle part to which is secured a coupling member 49 provided with a rearwardly directed engagement pin 43 as shown in FIGS. 5 and 6. The holder body 45, support shafts 33a and 33b, the engagement pin 43 and the coupling member 40 are formed integrally with one another as shown in FIGS. 5 and 6. The cutter holder 5 is vertically moved by the third moving unit 44 in conjunction with the engagement pin 43. Furthermore, compression coil springs 50 serving as biasing members are mounted about the support shafts 33a and 33b so as to be located between upper surfaces of the support portion and upper end of the holder boy 45, respectively. The entire cutter holder 5 is elastically biased upward by a biasing force of the compression coil springs 50 relative to the carriage 19.

Mounting members 51 and 52 provided for mounting the movable cylindrical portion 46, the pressing device 47 and the like are fixed to the middle portion of the holder body 45 by screws 54a and 54b respectively, as shown in FIGS. 3 and 4. The lower mounting member 52 is provided with a cylindrical portion 52a (see FIG. 5) which supports the movable cylindrical portion 46 so that the movable cylindrical portion 46 is vertically movable. The movable cylindrical portion 46 has a diameter that is set so that the movable cylindrical portion 46 is brought into a sliding contact with the inner peripheral surface of the cylindrical portion 52a. The movable cylindrical portion 46 has an upper end on which a flange 46a supported on an upper end of the cylindrical portion 52a is formed so as to expand radially outward. A spring shoe 46b is provided on an upper end of the flange 46a. A compression coil spring 53 is interposed between the upper mounting member 51 and the spring shoe 46b of the movable cylindrical portion 46 as shown in FIGS. 5 and 6. The compression coil spring 53 biases the movable cylindrical portion 46 (the cutter 4) to the lower object 6 side while allowing the upward movement of the movable cylindrical portion 46 against the biasing force when an upward force acts on the cutter 4.

The cutter 4 is provided in the movable cylindrical portion 46 so as to extend therethrough in the axial direction. In more detail, the cutter 4 has a round bar-like cutter shaft 4b which is longer than the movable cylindrical portion 46 and a blade 4a integrally formed on a lower end of the cutter shaft 4b. The blade 4a is formed into a substantially triangular shape and has a lowermost blade edge 4c formed at a location offset by a distance d from a central axis O of the cutter shaft 4b, as shown in FIG. 8. The cutter 4 is held by bearings 55 (see FIG. 5) mounted on upper and lower ends of the movable cylindrical portion 46 so as to be rotatably movable about the central axis O (the Z axis) in the vertical direction. Thus, the blade edge 4c of the cutter 4 presses an X-Y plane or the surface of the object 6 from the Z direction perpendicular to the X-Y plane. Furthermore, the cutter 4 has a height that is set so that when the cutter holder 5 has been moved to a lowered position, the blade edge 4c passes through the object 6 on the holding sheet 10 but does not reach the upper surface of the plate member 3b of the platen 3, as shown in FIG. 8. On the other hand, the blade edge 4c of the cutter 4 is moved upward with movement of the cutter holder 5 to the raised position, thereby being departed from the object 6 (see FIG. 5).

Three guide holes 52b, 52c and 52d (see FIGS. 3 to 5 and 11) are formed at regular intervals in a circumferential edge of the lower end of the cylindrical portion 52a. A pressing member 56 is disposed under the cylindrical portion 52a and has three guide bars 56b, 56c and 56d which are to be inserted into the guide holes 52b to 52d respectively. The pressing member 56 includes a lower part serving as a shallow bowl-shaped pressing portion body 56a. The aforementioned equally-spaced guide bars 56b to 56d are formed integrally on the circumferential end of the top of the pressing portion body 56a. The guide bars 56b to 56d are guided by the respective guide holes 52b to 52d, so that the pressing member 56 is vertically movable. The pressing portion body 56a has a central part formed with a through hole 56e which vertically extends to cause the blade 4a to pass therethrough. The pressing portion body 56a has an underside serving as a contact portion 56f which is brought into contact with the object 6 while the blade 4a is located in the hole 56e. The contact portion 56f is formed into an annular horizontal flat surface and is brought into surface contact with the object 6. The contact portion 56f is made of a fluorine resin such as Teflon® so as to have a lower coefficient of friction, whereupon the contact portion 56f is rendered slippery relative to the object 6.

The pressing portion body 56a has a guide 56g which is formed integrally on the circumferential edge thereof so as to extend forward, as shown in FIGS. 3 to 5 and 11. The guide 56g is located in front of and above the contact portion 56f and includes an inclined surface 56ga inclined rearwardly downward to the contact portion 56f side. Consequently, when the holding sheet 10 holding the object 6 is moved rearward relative to the cutter holder 5, the object 6 is guided downward by the guide 56g so as not to be caught by the contact portion 56f.

The mounting member 52 has a front mounting portion 52e for the solenoid 57, integrally formed therewith. The front mounting portion 52e is located in front of the cylindrical portion 52a and above the guide 56g. The solenoid 57 serves as an actuator for vertically moving the pressing member 56 thereby to press the object 6 and constitutes a pressing device 47 (a pressing unit) together with the pressing member 56 and a control circuit 61 which will be described later. The solenoid 57 is mounted on the front mounting portion 52e so as to be directed downward. The solenoid 57 includes a plunger 57a having a distal end fixed to the upper surface of the guide 56g. When the solenoid 57 is driven with the cutter holder 5 occupying the lowered position, the pressing member 56 is moved downward together with the plunger 57a thereby to press the object 6 with a predetermined pressure (see FIG. 11). On the other hand, when the plunger 57a is located above during non-drive of the solenoid 57, the pressing member releases the object 6 from application of the pressing force. When the cutter holder 5 is moved to the raised position during non-drive of the solenoid 57 (see two-dot chain line in FIG. 5), the pressing member 56 is completely departed from the object 6.

The holding sheet 10 has an adhesive layer 10a (see FIG. 8) which holds the object 6. The object 6 is immovably held on the holding sheet 10 by a resultant force of adhesion of the adhesive layer 10a and a pressing force of the pressing device 47. The configurations of the holding sheet 10 and the pressing device 47 will now be described with additional reference to FIGS. 8 and 9. The holding sheet 10 is made of, for example, a synthetic resin and formed into a flat rectangular plate shape, as shown in FIG. 1. The holding sheet 10 is placed opposite the cutter 4 and has a side (a side opposite the cutter 4) on which an adhesive layer 10a (see FIG. 8) is formed by applying an adhesive agent to the holding sheet 10. The sheet-like object 6 such as paper, cloth, resin film or the like is removably held by the adhesive layer 10a. The adhesive layer 10a has an adhesion that is set to a small value such that the object 6 can easily be removed from the adhesive layer 10a without breakage of the object 6.

When reference symbol F_{N} designates a holding force necessary to hold the object 6 so that the object 6 is immovable relative to the holding sheet 10, the adhesive layer 10a is set at an adhesion F_{S} that is smaller than F_{N}. More specifically, the adhesion F_{S} is weaker than in the conventional structure in which the object is held only by the adhesion of the adhesive layer. The pressing force F_{P} of the pressing device 47 by actuation of the solenoid 47 is set so that a resultant force of the pressing force F_{P} and the adhesion F_{S} of the adhesive layer 10a meets the necessary holding force F_{N}. The necessary holding force F_{N} in this case is shown by the following equation (1):

F_{N}≦F_{S}+F_{P} (1)

In the cutting apparatus 1, the resultant force of the pressing force F_{P} and the adhesion F_{S} is thus set to be not less than the necessary holding force F_{N} so that the object 6 is prevented from being displaced from the holding sheet 10 when the object 6 is cut by the cutter 4.

FIG. 9 shows the relationship between the adhesion F_{S} of the adhesive layer 10a and the objects 6A and 6B. In the case where the adhesion F_{S} of the adhesive layer 10a exceeds FA_{H}, the object 6A is broken when removed from the adhesive layer 10a, and the object 6A cannot be held when the adhesion F_{S} is less than FA_{L}. Accordingly, the adhesion F_{S} can be ranged from FA_{H} to FA_{L}. On the other hand, the object 6B cannot be held by the holding member 10 when the adhesion F_{S} is not equal to or not larger than FB_{H}, and in the case where the object 6B is broken when the adhesion F_{S} is larger than FB_{L}. Accordingly, the object is displaced from the holding sheet during the cutting in the conventional construction no matter how carefully the adhesion is adjusted, or the object 6B is broken when removed from the holding sheet. The conventional construction thus has the above-described problems.

In the embodiment, however, the pressing force F_{P} of the pressing device 47 is set at the value corresponding to the difference (FB_{H}−FB_{L}) regarding the object 6B. In this case, even when F_{S} is equal to FB_{L}, the object 6B can be held on the holding sheet 10 during cutting, and the object 6B can be prevented from breakage when removed from the holding sheet 10. Thus, the pressing force F_{P} and the adhesion F_{S} of the adhesive layer 10 are set according to the type, property of the object 6 or the like so that the object 6B on the holding sheet 10 can reliably be prevented from displacement during cutting and the object 6B can be prevented from breakage when removed from the holding sheet 10. The resultant force of the foregoing pressing force F_{P} and the adhesion F_{S} designates a single force which has an equal effect to these plural forces F_{P} and the adhesion F_{S}.

The arrangement of the control system of the cutting apparatus 1 will now be described with reference to a block diagram of FIG. 10. A control circuit (a control unit) 61 controlling the entire cutting apparatus 1 mainly comprises a computer (CPU) as shown in FIG. 10. A ROM 62, a RAM 63 and an external memory 64 each serving as a storage unit are connected to the control circuit 61. The ROM 62 stores a cutting control program for controlling the cutting operation, the threshold of a cutting angle and various control data and the like. The external memory 64 stores data of a plurality of cutting data and the like. The RAM 63 is provided with storage areas for temporarily storing various data and program necessary for execution of each processing.

Operation signals are supplied from the various operation switches 65 to the control circuit 61. The control circuit 61 controls a displaying operation of the LCD 9. In this case, while viewing the displayed contents of the LCD 9, the user operates the switches 65 to select and designate cutting data of a desired pattern. Detection signals are also supplied from various sensors 66 such as a sensor for detecting the holding sheet 10 set from the opening 2a of the cutting apparatus 1. To the control circuit 61 are connected drive circuits 67 to 70 driving the Y-axis, X-axis and Z-axis motors 15, 26 and 34 and the solenoid 57. Upon execution of the cutting control program, the control circuit 61 controls various actuators such as the Y-axis, X-axis and Z-axis motors 15, 26 and 34 and the solenoid 57, based on the cutting data, whereby the cutting operation is automatically executed for the object 6 on the holding sheet 10.

The control circuit 61 is configured as a control unit which controls the current supplied to the solenoid 57 to set the pressing force of the pressing device 47 at the aforesaid F_{P}. More specifically, the control circuit 61 controls the solenoid 57 to protrude the plunger 57a downward so that the pressing force FP is generated at the contact portion 56f of the pressing member 56 against the object 6. The pressing device 47 thus presses the object 6 against the contact surface of the object 6 in the Z direction perpendicular to the contact surface of the object 6, with which the contact portion 56f is brought into contact. The control to set the pressing force FP is adapted to be executed as a pressing force setting routine when the object 6 is cut by the cutter 4.

The operation of the cutting device 1 will be described. The cutter holder 5 occupies a raised position before the object 6 is cut, as shown in FIG. 5. In this state, the user affixes the object 6 to the adhesive layer 10a such that the object 6 is held by the holding sheet 10. The user then sets the holding sheet 10 to the cutting apparatus 1 from the opening 2a and operates the operation switches 65 to select, for example, a desired one of the cutting data stored in the external memory 64 so that a cutting operation is executed. Upon start of the cutting operation, the holding sheet 10 is firstly held between the driving roller 12 and the pinch roller 13 to be conveyed in the Y direction in order that the object 6 may be moved to a cut starting point. In this case, the object 6 is prevented from being caught by the contact portion 56f of the pressing member 56 even when the solenoid 57 is driven before the object 6 reaches the cut starting position. More specifically, the pressing member 56 is formed with a guide 56g having an inclined surface inclined toward and continuous to the contact portion 56f. Accordingly, the guide 56g prevents the object 6 from being caught by the contact portion 56f even when the set holding sheet 10 is moved rearward while the pressing member 56 occupies a position shown by solid line in FIG. 5.

When the object 6 has reached the cut starting point, the Z-axis motor 34 is driven to move the cutter holder 5 to the lowered position (see FIG. 11). The holding sheet 10 and the cutter 4 of the cutter holder 5 are moved relative to each other by the first and second moving units 7 and 8 on the basis of the cutting data respectively, whereby the object 6 is cut. The contact portion 56f applies the pressing force F_{P} to the object 6 as the result of drive of the solenoid 57 during the cutting operation. Accordingly, the object 6 is held by both the adhesion F_{S} of the adhesive layer 10a of the holding sheet 10 and the pressing force F_{P} so as not to be displaced relative to the holding sheet 10. Furthermore, the pressing member 56 is moved relative to the object 6 during the cutting. However, since the contact portion 56f of the pressing member 56 is made of a material having a lower frictional coefficient than the object 6, a frictional force produced between the contact portion 56f and the object 6 can be reduced as much as possible. Consequently, the object 6 can be prevented from displacement due to the frictional force, whereupon the object can be held more reliably.

When the cutting of the object 6 has been finished, the user removes the object 6 from the holding sheet 10. In this case, since the adhesive layer 10a of the holding sheet 10 has the adhesion set at the value F_{S}, the object 6 can easily be removed from the holding sheet 10.

As described above, the pressing force F_{P} is set at the value such that the resultant force of the adhesion F_{S} of the adhesive layer 10a and the pressing force F_{P} of the pressing device 47 meets the holding force F_{N} necessary to immovably hold the object 6 relative to the holding sheet 10 when the object 6 is cut by the cutter 4.

Consequently, the object 6 can immovably be held on the holding sheet 10 by the resultant force of the adhesion F_{S} of the adhesive layer 10a and the pressing force F_{P} of the pressing device 47. Accordingly, the object 6, when cut, can reliably be prevented from displacement on the holding sheet 10, whereupon the object 6 can accurately be cut into a desired shape. Since the necessary holding force required of the holding sheet 10 can be compensated for by the pressing force FP of the pressing device 47, the adhesion F_{S} of the adhesive layer 10a can be set to be weaker than in the conventional construction in which the object is held on the holding member only by the adhesion. Thus, the object 6 can easily be removed from the holding sheet 10 (the adhesive layer) without breaking the holding sheet after, for example, a sheet such as paper, serving as the object 6 has been cut.

The pressing device 47 includes the contact portion 56f which is brought into contact with the object 6 and made of the material with the lower frictional coefficient. The contact portion 56f can reduce the frictional force between the pressing member 56 and the object 6. Accordingly, the relative movement of the object 6 can smoothly be carried out while the object 6 is being pressed by the contact portion 56f of the pressing device 47.

The pressing device 47 is configured to press the object 6 in the direction perpendicular to the contact surface of the object 6 brought into contact with the contact portion 56f. Consequently, since the contact portion 56f can efficiently press the object 6, the object 6 can reliably be held.

The pressing device 47 includes the guide 56g which guides the object 6 to prevent the object 6 held by the holding sheet 10 from being caught by the contact portion 56f. The object 6 can be held so. as not to displace on the holding sheet 10. Consequently, the object 6 can be cut more accurately.

### Second Embodiment

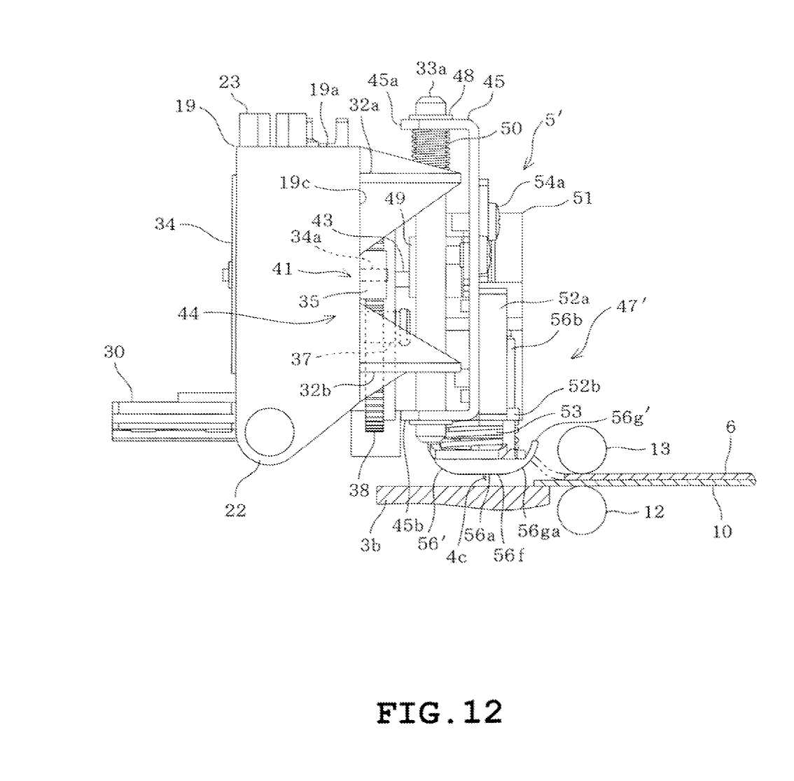

FIG. 12 illustrates a second embodiment. Only the difference between the first and second embodiments will be described. Identical or similar parts in the second embodiment are designated by the same reference symbols as those in the first embodiment. The cutter holder 5′ in the second embodiment differs from the cutter holder 5 of the first embodiment in the following. The solenoid 5⁷, the mount 52e and the like are eliminated in the cutter holder 5′ and a compression coil spring 53 is disposed between the pressing member 56′ and the movable cylinder 46. The pressing member 56′ is held at a predetermined vertical position relative to the holder body 45. When the cutter holder 5′ occupies the lowered position as shown in FIG. 12, the contact portion 56f of the pressing member 56 presses the object 6 with the aforementioned pressing force F_{P}. Thus, the pressing device 47′ is constituted by the pressing member 56′, the third moving unit 44, the control circuit 61, the compression coil spring 44 and the like. Consequently, the control to set the pressing force FP is executed by vertically moving the cutter holder 5 by the third moving unit 44.

Furthermore, the pressing member 56′ has the guide 56g′ formed integrally therewith. The guide 56g′ extends obliquely upward in front of the contact portion 56f. The guide 56g′ is formed into an arc shape and is continuous to the contact portion 56f so as to be inclined toward the contact portion 56f. As a result, as shown in FIG. 12, even if a part of the object 6 is turned upward from the holding sheet 10, the object 6 is guided by the guide 56g′ so as not to be caught by the contact portion 56f in the same manner as the guide portion 56g.

In the second embodiment, the solenoid 57 and the like are eliminated and the pressing member 56′ is held via the compression coil spring 53 at the predetermined position on the holder body 45, as described above. Thus, the pressing force F_{P} applied to the object 6 can be obtained by the simple construction. Furthermore, the pressing force F_{P} is suitably adjustable by changing the spring constant of the compression coil spring 53. Furthermore, the guide portion 56g can prevent the object 6 from being caught by the contact portion 56f or the vicinity thereof. The second embodiment can thus achieve substantially the same effect as the first embodiment.

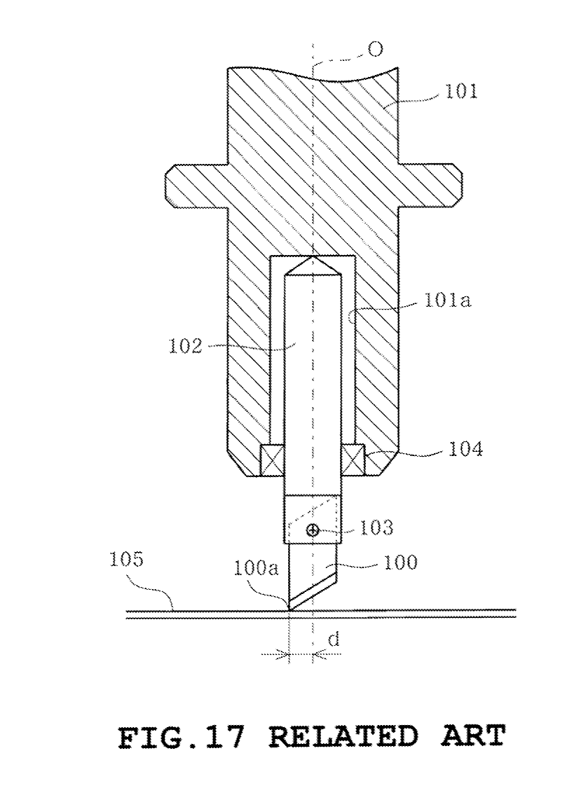

Meanwhile, since the conventional cutting apparatus is not provided with a pressing unit applying the pressing force F_{P} to the object, there is a possibility that the object may displace from the sheet-like member during the cutting even when the sheet-like member has an adhesive layer. In particular, the cutter 100 as shown in FIG. 17 is rotatable about the axis O and accordingly, there is a possibility that corners of a cutting line of the sheet 105 as the object to be cut cannot be accurately cut. For example, when a cutting line is composed of first and second line segments which are formed into a V shape, the blade edge of the cutter 100 is directed to the direction of the first line segment at a cutting end point of the first line segment. Thereafter, the blade edge of the cutter 100 is changed to the direction of the second line segment when the cutting of the second line segment starts. As a result, even when the aforesaid sheet-like member is used, the corner where the direction of the blade edge of the cutter 100 is changed may cause burr during the cutting. This problem is more noticeable when an angle made between the first and second segments is acute or when the sheet 105 has a large thickness. Thus, it has been difficult to sufficiently hold the object so that the corners can be prevented from being burred in spite of the adhesion of the sheet-like member.

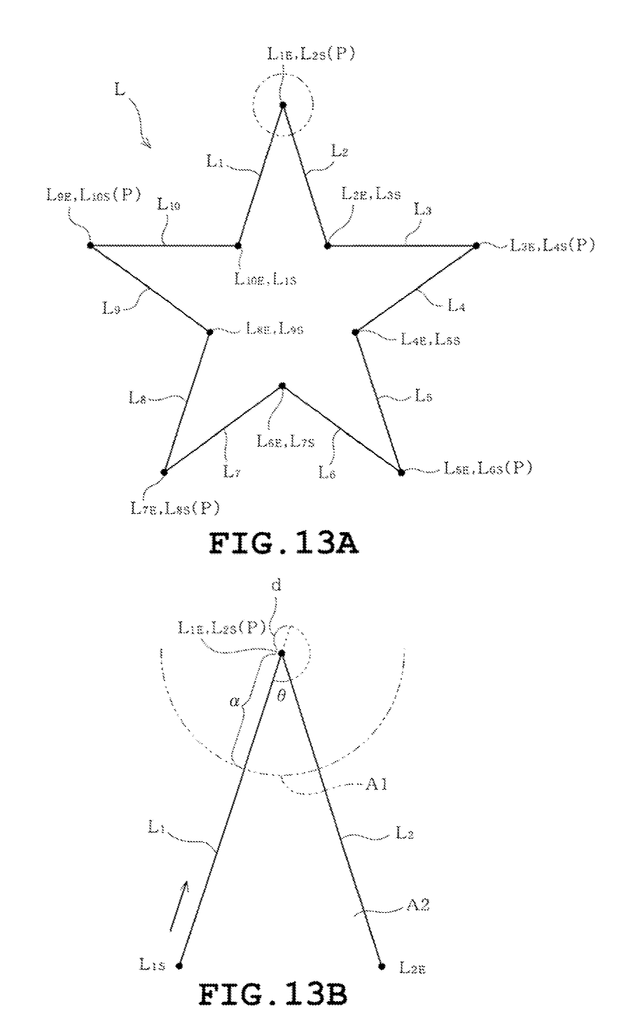

In view of the above-described problem, the cutting apparatus of the following third embodiment specifies a region, such as the aforesaid corners, which is located along a cutting line of the object 6 and in which the adhesive holding force is relatively insufficient. The pressing force F_{P} is changed between the case where the specified region is cut and the case where a part other than the specified region is cut, so that burr is reliably prevented from occurring at the corners. In the following description, a case where the pattern of a star is cut from the object 6 held by the holding sheet 10 as shown in FIG. 13A.

### Third Embodiment

FIGS. 13A to 16 illustrate the third embodiment. Only the differences between the first and third embodiments will be described. The identical or similar parts in the third embodiment are labeled by the same reference symbols as those in the first embodiment.

Firstly, the cutting data includes line segment data corresponding to n number of line segments L₁ to Lₙ composing the cutting line L. For example, when the pattern of a star is cut out of the object as shown in FIG. 13A, the cutting data has data of ten line segments comprising ten line segments L₁ to Lₙ composing the cutting line L. More specifically, the line segments L₁ to L₁₀ have start points L_{1S} to L_{10S} and end points L_{1E} to L_{10E} respectively. The line segments L₁ to L₁₀ are continuous and constitute a closed single cutting line. Accordingly, start points of the line segments correspond with end points of the neighboring line segments respectively. The start and end points of the line segments L₁ to L₁₀ of the line segment data are shown by X-Y coordinates respectively. The X-Y coordinates have as an origin an apex located at the rear side in the Y-axis direction as a sheet feeding direction and at the start point side in the direction of the X-axis as a moving direction of the cutter 4.

The RAM 63 stores the cutting data including the above-mentioned data of n number of line segments read from the external memory 64. Consequently, when the object 6 is cut by the cutting apparatus 1, the line segments L₁ to L₁₀ are cut based on the cutting data stored in the RAM 63. In this case, in the cutting of the object 6 by the cutting apparatus 1, the holding sheet 10 (the object 6) is conveyed in the Y direction by the first moving unit 7 of the cutting apparatus 1 and the cutter holder 5 is moved in the X direction by the second moving unit 8, based on the cutting data, whereby the cutter 4 is moved to the X-Y coordinate of the start point L_{1S} of the line segment L₁ relative to the holding sheet 10 with the object 6. Subsequently, the blade edge 4c of the cutter 4 is caused to pass through the start point L₁₅ of the object 6 by the third moving unit 44. The holding sheet 10 with the object 6 and the cuter holder 5 with the cutter 4 are then moved by the first and second moving units 7 and 8 relative to each other respectively thereby to be moved toward the coordinate of the end point L_{1E} of the line segment L₁, whereby the object 6 is cut along the line segment L₁. The subsequent line segment L₂ is continuously cut in the same manner as the line segment L₁ with the previous line segment L₁ serving as the start point L_{2S}. The cutting is also executed continuously in the cutting sequence of the line segment data with respect to each of the line segments L₂ to L₁₀, whereupon the cutting line L of the star pattern is cut.

The threshold of the cutting angle stored in the ROM 62 is indicative of an angle θ made between neighboring line segments L₁ and L₂ as shown in FIG. 13B. The threshold T of the cutting angle is set at a predetermined value (130°, for example) and compared with the angle θ made between an (i−1)-th line segment Lᵢ₋₁ to be cut and an i-th line segment Lᵢ to be cut. When the angle θ is not more than the threshold T, the control circuit 61 specifies a region around apex P as a region A1 where an adhesive retention of the adhesive layer 10a is insufficient along the cutting line L. The control circuit 61 thus constitutes a region specifying unit. The region A1 is specified on the basis of the threshold T. For example, the region A1 includes a part that is easily turned upward during cutting, such as an acute-angled corner made between the line segments L₁ and L₂ as shown in FIG. 13B, or a part including a corner that is easily drooped. The easily drooped corner refers to a slightly rounded distal end of a corner. In this case, for example, reference symbol “A1” designates a region in the range of a predetermined distance from the apex P of the corner and reference symbol “A2” designates a region other than the region A1. Accordingly, the region A2 includes a part other than the region A1 and an obtuse-angled portion where the cutting angle exceeds the predetermined value.

The blade edge 4c of the cutter 4 is offset from the central axis O of the cutter 4 by the distance d as described above (see FIG. 8), so that the blade edge 4c is subjected to a resistive force (hereinafter referred to as “cutting resistive force”) from the object 6 with relative movement of the cutter 4 and the object 6. Accordingly, the cutter 4 is turned about the central axis O or in other words, with the relative movement of the cutter 4 and the object 6, the cutter 4 automatically changes its direction along the direction of the relative movement.

More specifically, cutting is firstly carried out along the line segment L₁ in the direction of arrow when the corner of the region A1 in the cutting line L of the star is cut, as shown in FIG. 13B. In this case, when the cutting blade 4a of the cutter 4 has reached the apex P (end point L_{1E}), the central axis O occupies a position located away by distance d from the apex P on an extended line from the line segment L₁. Since the blade edge 4c is subsequently changed to the direction along the line segment L₂, the cutter 4 is moved so that the central axis O is along the broken line (arc). Thereafter, the line segment L₂ is cut. In this case, the blade edge 4c passes through the object 6, biting slightly into the holding sheet 10, as shown in FIG. 8. Accordingly, a part corresponding to the apex P is slightly burred by the blade edge 4c. Furthermore, the part has a region which is in contact with the adhesive layer 10a and gradually becomes smaller and the adhesion retention of the adhesive layer 10a become weaker as it comes close to the distal end thereof. As a result, the corner of the region A1 is turned upward or burred. This problem is noticeable when the cutting angle θ is acute and/or the sheet is thick.

In view of the problem, the control circuit 61 in the embodiment is configured to control the current supplied to the solenoid 57 so that the pressing force of the pressing device 47 pressing the object 6 is changed or differentiated between a case where the region A1 is cut and a case where the region A2 other than the region A1 is cut. More specifically, in the case where the region A1 is cut, a resultant force of the adhesion F_{S} of the adhesive layer 10a of the holding sheet 10 and the pressing force F_{P1} is set to meet a holding force F_{N1} necessary to hold the object 6 so that the corner of the region A1 is not turned over (or the corner is burred). The necessary holding force F_{N1} in this case is shown by the following expression (2):

F_{N1}≦F_{S}+F_{P1} (2)

Furthermore, in the case where the region A2 is cut, a resultant force of the adhesion F_{S} of the adhesive layer 10a of the holding sheet 10 and the pressing force F_{P2} of the pressing device 47 is set to meet a holding force F_{N2} necessary to hold the object 6 so that the object 6 is immovably held by the holding sheet 10 against the cutting resistance in the region A2. The necessary holding force F_{N2} in this case is shown by the following expression (3):

F_{N2}≦F_{S}+F_{P2} (3)

In this case, since the pressing force F_{P1} in the region A1 is set so as to be stronger or larger than the pressing force F_{P2} in the region A2 (F_{P1}>F_{P2}), the corner can accurately be cut in the region A1 without causing the above-described problem. On the other hand, since the pressing force F_{P2} in the region A2 is weaker than the pressing force F_{P1}, the load resulting from the relative movement of the cutter 4 and the object 6 can be reduced.

The control circuit 61 is configured as a control unit which controls the current supplied to the solenoid 57 to set the pressing force of the pressing device 47 at the aforementioned F_{P1} or F_{P2}. More specifically, the control circuit 61 controls the solenoid 57 to be thrust downward so that the contact portion 56f of the pressing member 56 presses the object 6 with the pressing force F_{P1} or F_{P2}. The contact portion 56f of the pressing device 47 thus presses the object 6 in the Z direction perpendicular to the contact surface of the object 6.

The control circuit 61 is also configured as a speed control unit which controls the rotational speeds of the Y-axis and X-axis motors 15 and 26 in association with the pressing forces F_{P1}, and F_{P2} of the pressing device 47. More specifically, when the region A1 is to be cut, the control circuit 61 controls the motors 15 and 26 so that the relative moving speeds of the cutter 4 and the object 6 are the respective lower or first speeds. When the region A2 is to be cut, the control circuit 61 drives the motors 15 and 26 so that the relative moving speeds of the cutter 4 and the object 6 are the respective second speeds that are higher than the first speeds.

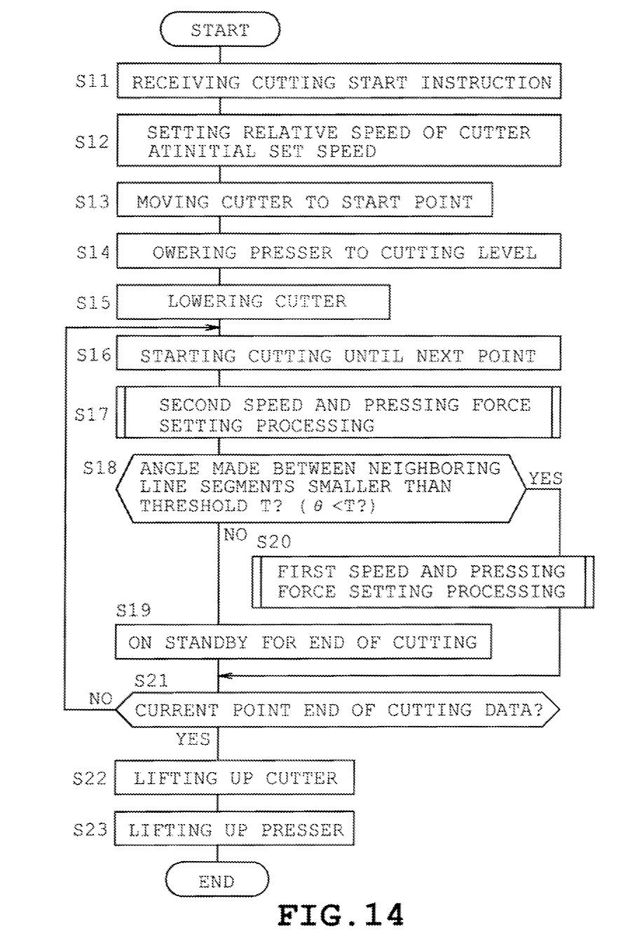

A concrete processing procedure of the cutting operation of the cutting apparatus 1 will now be described with reference to FIGS. 14 to 16, which are flowcharts showing processing flows of the cutting control program executed by the control circuit 61 respectively. In the figures, a symbol Si (where i=11, 12, 13 and . . . ) designates each step. The shape to be cut is the aforesaid “star” and ordinary paper is used as the object 6.

When the object 6 is to be cut by the cutting apparatus 1, the user sets the holding sheet 10 holding the object 6, from the opening 2a of the cutting apparatus 1 in the same manner as in the first embodiment. When the user has selected desired cutting data stored in the external memory, for example, the selected cutting data is stored in a memory of the RAM 63. Upon operation of the operation switches 65, the control circuit 61 starts the cutting operation based on the operation signal (step S11).

In the cutting operation, firstly, the moving speed of the cutter 4 relative to the object 6 is set at an initial set speed (the second speed (higher speed), for example) (step S12). Subsequently, the Y-axis and X-axis motors 15 and 26 are driven so that the blade edge 4c of the cutter 4 is moved to the cutting start point L_{1S} of the object 6 (see FIG. 13B). In this case, the cutter 4 is moved at a higher speed in the X-Y direction relative to the object 6 while being vertically located away from the object 6. When the cutter 4 has been moved to the cutting start point L_{1S}, the control circuit 61 drives the solenoid 57 so that the pressing member 56 presses the object 6 with a relatively weaker pressing force F_{P2} (step S14). The control circuit 61 further drives the Z-axis motor 34 so that the cutter holder 5 is moved to the lowered position, whereby the blade edge 4c of the cutter 4 is caused to pass through the cutting start point L_{1S} (step S15).

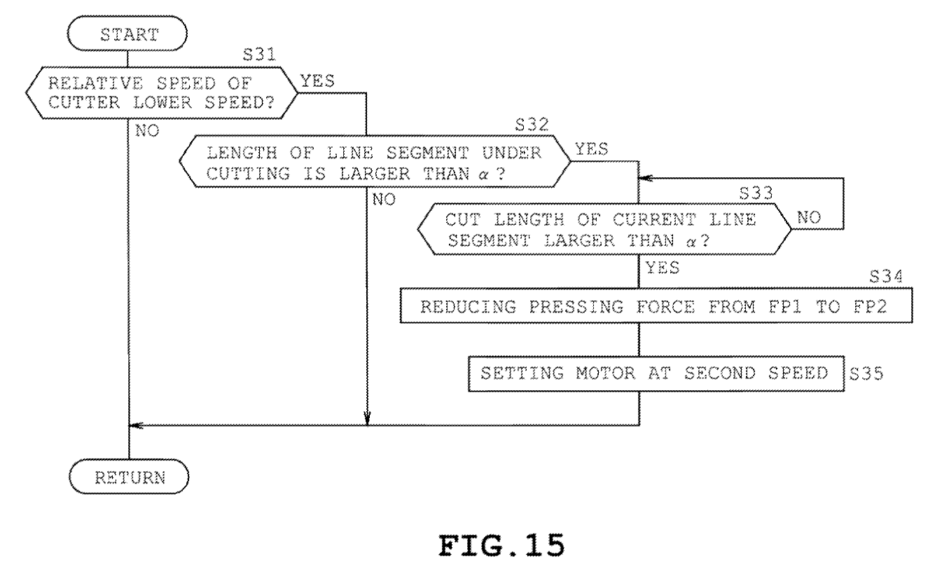

The motors 15 and 26 are driven to move the holding sheet 10 and the cutter 4 respectively so that the cutter 4 is moved to the coordinate (see FIG. 13B) of end point L_{1E} of the line segment L₁, whereby the cutting of the line segment L₁ is started (S16). In this case, a second speed setting processing for the Y-axis and X-axis motors 15 and 26 is executed at step S17 (see FIG. 15). In the second speed setting processing, when the relative speed of the cutter 4 is set at the first speed (lower speed) (YES at step S31), the relative speed of the cutter 4 is changed to the second speed (higher speed). Since the relative speed of the cutter 4 has been set at the second speed (higher speed) by the initial setting (NO at step S31), the change to the second speed will be described later (the control circuit 61 returns to step S18 in FIG. 14).

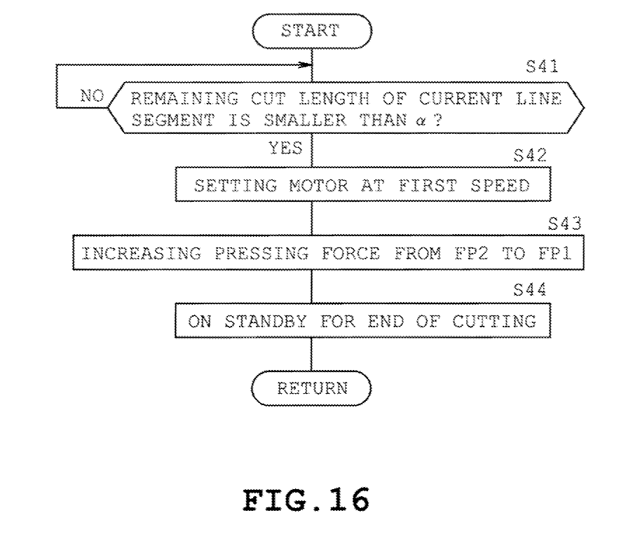

The control circuit 61 computes the angle 8 made by the line segment L₁ including the cutting start point L_{1S} and the line segment L₂ to be subsequently cut, based on the line segment data of L₂. When the angle 8 exceeds the threshold T (NO at step S18), the cutter 4 is moved to the end point L_{1E} while the second speed is maintained (step S19). On the other hand, when the angle 8 is not more than the threshold T, that is, when an acute corner such as apex P in FIG. 13B is to be cut (YES at step S18), a first speed setting processing is executed at step S20 (see FIG. 16).

In the first speed setting processing, it is determined whether or not a remaining length of the currently cut line segment L₁ is shorter than the distance α at step S41. In this case, the control circuit 61 is on standby for the remaining length being reduced below the distance α (when the cutter 4 reaches the region A1), the relative moving speed of the cutter 4 is changed from the second speed (higher speed) to the first speed (lower speed), whereupon the cut 4 is set at the lower speed (step S42). Simultaneously, the control circuit 61 controls a drive current of the solenoid 57 to change the pressing force of the pressing device 47 from F_{P2} to F_{P1} (step S43). As a result, the object 6 is pressed by the contact portion 56f of the pressing member 56 with the pressing force F_{P1} in the region A1 (FIG. 13B) so that the object 6 is not turned upward. In this state, the cutter 4 is moved so that the blade edge 4c thereof reaches the apex P (end point L_{1E} of L₁) (step S44). Thereafter, the control circuit 61 returns to step S21 in FIG. 14.

The control circuit 61 determines at step S21 whether or not the blade edge 4c of the cutter 4 is currently located at the end point L_{10E} of the cutting line L, that is, whether or not the cutting of all the line segments L₁ to L₁₀ has ended. In this case, since the line segments L₂ to L₁₀ have not been cut (NO at step S21), the control circuit 61 starts the cutting of the line segment L₂ until the end point L_{2E} is reached (step S16). The second speed setting processing is executed at step S17 (see FIG. 15).

In the second speed setting processing, the control circuit 61 determines at step S31 whether or not the moving speed of the cutter 4 relative to the object 6 is set at the first speed (lower speed). When determining that the moving speed of the cutter 4 relative to the object 6 is set at the first speed (YES at step S31) and that the line segment L₂ exceeds the distance α (YES at step S32), the control circuit 61 determines that the moving speed of the cutter 4 relative to the object 6 is set at the first speed (lower speed) in the cutting of the line segment L₂ and maintains the pressing force F_{P1}. More specifically, when the blade edge 4c has reached the apex P, the cutter 4 is changed to the direction of the line segment L₂, whereupon a clear acute cutting can be executed. Moreover, since the moving speed of the cutter 4 relative to the object 6 is set at the first speed (lower speed), a continuous stable cutting can be executed without step-out of the motors 15 and 26 in spite of strong pressing force F_{P1}. Thus, when having finished the cutting of the line segment L₂ by distance α (region A₁) (YES step A33), the control circuit 61 changes the pressing force of the pressing device 47 from F_{P1} to F_{P2} (step S34). The control circuit 61 further changes the moving speed of the cutter 4 relative to the object 6 from the first speed (lower speed) to the second speed (higher speed). More specifically, the control circuit 61 sets the relative moving speed of the cutter 4 to the second speed (higher speed) (step S35), returning to step S18 in FIG. 14. When determining at step S32 that the length of the line segment L₂ has not exceeded the distance α, the control circuit 61 maintains the pressing force F_{P1} in the cutting of the line segment L₂ and the first speed (lower speed).

The control circuit 61 computes an angle θ made between the line segment L₂ and the line segment L₃ to be subsequently cut, based on line segment data of L₃. The control circuit 61 then compares an angle α obtained by computation with the threshold T, thereby executing the same cutting processing as the first line segment L₁ with respect to line segment L₂ or the first speed setting processing (steps S19 and S20). Steps S16 to S21 are thus repeated in the sequence of line segments L₁ to L₁₀, the cutting processing is executed with the suitable moving speed and the suitable pressing forces F_{P1} and F_{P2} for every regions A1 and A2 in each of the line segments L₁ to L₁₀. Furthermore, since the pressing force is increased at five corners as shown by “P” in FIG. 13A in the cutting processing, the object can be cut with clear acute lines. When determining that the cutting has been executed up to the end point L10E of the cutting line L of the “star” pattern (YES at step S21), the control circuit 61 moves the cutter holder 5 to the raised position (step S22), deactivates the solenoid 57 and moves the pressing member 56 upward (step S23), ending the processing.

Upon finishing the cutting of the object 6, the user removes the object 6 from the holding sheet 10. In this case, since the adhesion of the adhesive layer 10a of the holding sheet 10 is set at the aforesaid value F_{S}, the object 6 can easily be removed from the holding sheet 10. In the third embodiment, steps S17, S20, S34 and S43 serve as a pressing force setting routine of setting the pressing forces F_{P1} and F_{P2} of the pressing device 47. Steps S18, S32, S33 and S41 serve as a region specifying routine of specifying the region where the adhesive retention of the adhesive layer 10a. The control circuit 61 serves as a control unit and controls the pressing device 47 so that the pressing force of the contact portion 56f applied to the object 6 is differentiated or changed between a case where the region A1 specified by the region specifying routine is cut and a case where the region A2 other than the region A1 is cut.

According to the third embodiment, the object 6 can be held both by the adhesion of the adhesive layer 10a of the holding sheet 10 and by the pressing force of the pressing device 47. The region A1 where the adhesive retention is insufficient, such as the corners of the cutting line L, is specified by the region specifying routine. When the region A1 is to be cut, the pressing force applied to the object 6 is increased so that the pressing force is differentiated or changed from that in the cutting of the other region A2. As a result, the region A1 where the adhesive retention is insufficient is pressed by the contact portion 56f of the pressing device 47 thereby to be held so as not be turned upward, whereupon the region A1 can be accurately cut along the cutting line L.

The control circuit 61 serves as a speed control unit and executes the speed control routine of controlling the moving speeds of the cutter 4 and the object 6 relative to each other. The control circuit 61 is configured to differentiate or change the relative moving speed of the cutter 4 between the case where the region A1 is cut and the case where the region A2 other than the region A1 is cut. According to this configuration, the moving speed of the cutter 4 relative to the object 6 can be changed according to the pressing forces F_{P1} and F_{P2} pressing the object 6. Accordingly, when the load due to the movement of the cutter 4 relative to the object 6 is increased, the moving speed can be controlled so as to take a suitable value according to the load. Furthermore, when the load due to the movement of the cutter 4 relative to the object 6 is reduced, the relative moving speed of the cutter 4 is increased such that the cutting time can be reduced.

The control circuit 61 further serves as the region specifying unit and executes the region specifying routine of specifying the region A1 where the angle θ made by the neighboring line segments Lᵢ₋₁ and Lᵢ is not more than the threshold T. According to this configuration, the region A1 including the corner of the cutting line L tends to be easily turned upward during the cutting and can be specified. Accordingly, since the specified region A1 is pressed by the contact portion 56f of the pressing device 47, the object 6 can be prevented from being turned upward, whereupon the object 6 can be cut clearly.

The foregoing embodiments are not restrictive but may be modified or expanded as follows. Although the cutting apparatus 1 is applied to the cutting plotter, the apparatus may be applied to various apparatuses with respective cutting functions. The pressing unit may be configured to move the pressing member upward and downward using another actuator such as an electric motor instead of the solenoid 57. Furthermore, the contact portion 56f may be made of a material having a low frictional coefficient except for fluorine resin such as Teflon. The surface of the contact portion 56f (the surface in contact with the object 6) may be coated with fluorine resin. Bright electroplating may be applied instead of the coating of fluorine resin.

The pressing device 47 may be controlled so that an amount of pressing the contact portion 56f applies to the object 6 is changed or differentiated between the case where the region A1 is cut and the case where the region A2 other than the region A1 is cut when the object 6 is cut. More specifically, when a relatively thicker sheet such as felt serving as the object 6 is cut, corners tend to be easily rounded. In view of the problem, the processing of increasing an amount of pressing the pressing member 56 applies to the region A1 is executed instead of the above-described step S43. In this case, since the pressing force of the solenoid 57 is improved, substantially the same processing as step S43 is executed. As a result, the height of the contact portion 56f can be adjusted so that the thickness of the sheet is suppressed. Accordingly, each corner can be cut so as to have a clear acute angle. In the case where an amount of pressing the contact portion 56f applies to the object 6 is controlled, the processing may be executed so that the height of the contact portion 56f is slightly increased when the region A2 is cut, instead of step S34.

Regarding the control unit in the first embodiment, the pressing force FP produced by drive of the solenoid 57 may be controlled so as to satisfy the expression (1). Also, regarding the control unit in the third embodiment, the pressing forces F_{P1} and F_{P2} may be controlled so as to satisfy the aforementioned expressions (2) and (3). More specifically, for example, the resultant force of the adhesion F_{S} and the pressing force F_{P1} may be set at the same value as the necessary holding force F_{N1}, and the resultant force of the adhesion F_{S} and the pressing force F_{P2} may be set at the same as the necessary holding force F_{N2}. Furthermore, the resultant force of the adhesion Fs and the pressing force F_{P1} may be set at a value exceeding the necessary holding force FN1, and the resultant force of the adhesion F_{S} and the pressing force F_{P2} may be set at the same as the necessary holding force F_{N2}.

The storage medium storing the cutting control program should not be limited to the ROM 62 of the cutting apparatus 1. The storage medium may be CD-ROM, a flexible disc, DVD, external memory 64, instead. In this case, data stored in the storage medium is read into the computer serving as the control unit of the cutting apparatus 1 to be executed, whereupon the same work and effect as in the above-described embodiments can be achieved.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutting apparatus in which a cutting blade and an object to be cut are moved relative to each other so that the object is cut by the cutting blade, the cutting apparatus comprising:
a holding member which is disposed at a position opposed to the cutting blade and has an adhesive layer removably holding the object; and
a pressing unit which presses the object held by the holding member, the pressing unit being set at a pressing force which meets a holding force necessary for a resultant force of an adhesion of the adhesive layer and the pressing force of the pressing unit to immovably hold the object relative to the holding member when the object is cut by the cutting blade.

2. The cutting apparatus according to claim 1, wherein the pressing unit has a contact portion which is brought into contact with the object and is made of a material having a lower frictional coefficient than the object.

3. The cutting apparatus according to claim 2, wherein the pressing unit is configured to press the object in a direction perpendicular to a contact surface of the object, the contact portion of the pressing unit being brought into contact with the contact surface of the object.

4. The cutting apparatus according to claim 2, wherein the pressing unit has a guide portion which guides the object held by the holding member so that the object is prevented from being caught by the contact portion during the relative movement of the holding member.

5. The cutting apparatus according to claim 1, wherein:
the pressing unit has a contact portion brought into contact with the object;
the cutting blade and the holding member holding the object are moved relative to each other based on cutting data, the cutting apparatus further comprising:
a region specifying unit which specifies a region where an adhesive retention of the adhesive layer is insufficient along a cutting line of the object cut by the cutting blade based on the cutting data; and
a control unit which controls the pressing unit so that when the object is cut by moving the cutting blade and the holding member holding the object relative to each other, at least either an amount of pressing or a pressing force of the contact portion against the object is changed between a case where the region specified by the region specifying unit is cut and a case where any part of the object other than the specified region is cut.

6. The cutting apparatus according to claim 5, further comprising a speed control unit which controls moving speeds of the cutting blade and the object relative to each other, the speed control unit being configured to change the moving speeds of the cutting blade and the object relative to each other between the case where the region specified by the region specifying unit is cut and the case where any part of the object other than the specified region is cut.

7. The cutting apparatus according to claim 5, wherein the cutting line contains a plurality of consecutive line segments, and the region specifying unit is configured to specify a region where an angle made by two adjacent line segments is not more than a predetermined threshold.

8. A storage medium which is computer-readable and stores a control program that is incorporated in a cutting apparatus including a holding member which is disposed at a position opposed to the cutting blade and has an adhesive layer removably holding an object to be cut and a pressing unit which presses the object held by the holding member, the control program being used to cut the object into a desirable pattern by moving the cutting blade and the holding member holding the object relative to each other, the control program comprising a pressing force setting routine of setting a pressing force of the pressing unit so that a resultant force to immovably hold the object relative to the holding member during cutting of the object by the cutting blade meets a retention force necessary for the holding Member to immovably hold the object.

9. The storage medium according to claim 8, wherein:
the pressing unit has a contact portion contacting the object and the control program further comprises a region specifying routine of specifying a region where an adhesive retention of the adhesive layer is insufficient along a cutting line of the object cut by the cutting blade based on the cutting data; and
in the pressing force setting routine, the pressing unit is controlled so that at least either an amount of pressing or a pressing force of the contact portion against the object is differentiated between a case where the region specified by the region specifying unit is cut and a case where any part of the object other than the specified region is cut.

10. The storage medium according to claim 9, wherein:
the control program further comprises a speed control routine of controlling moving speeds of the cutting blade and the object relative to each other; and
in the speed, control routine, the moving speeds of the cutting blade and the object relative to each other are differentiated between a case where the region specified by the region specifying unit is cut and a case where any part of the object other than the specified region is cut.

11. The storage medium according to claim 9, wherein the cutting line contains a plurality of consecutive line segments, and the control program is configured to specify a region where an angle made by two neighboring line segments is not more than a predetermined threshold.
